(19) United States
(12) Patent Application Publication
(10) Pub. No.: US 2021/0090174 A1
(43) Pub. Date: Mar. 25, 2021

(54) Rolling Feedback System For Financial And Risk Analysis Using Disparate Data Sources

(71) Applicant: FP Alpha, Inc., New York, NY (US)

(72) Inventors: Andrew ALTFEST, New York, NY (US); Luis QUIROZ, Mexico City (MX)

(73) Assignee: FP Alpha, Inc., New York, NY (US)

(21) Appl. No.: 17/027,458

(22) Filed: Sep. 21, 2020

Related U.S. Application Data
(60) Provisional application No. 62/902,897, filed on Sep. 19, 2019.

(51) Int. Cl. G06Q 40/06; G06Q 40/08; G06Q 40/00; G06Q 10/10; G06Q 40/02; G06N 20/00; G06F 16/2457; G06F 16/23; G06F 7/548; G06F 40/40

(52) U.S. Cl. CPC G06Q 40/06; G06Q 40/08; G06Q 40/10; G06Q 10/10; G06F 40/40; G06N 20/00; G06F 16/24575; G06F 16/2358; G06F 7/548; G06Q 40/025

(57) ABSTRACT

This computerized rolling feedback system is for financial and risk analysis using disparate data sources comprising: a ruleset stored on a first computer readable media having a sub-ruleset associated with a subject matter wherein the subject matter is taken from the group consisting of income, tax, insurance, debt, risk, health care, estate planning, education, or any combination thereof; a target database having a set of target records with each target record having target attributes; and a recommendation engine including recommendation computer readable instructions for receiving target input associated with a new target and subject matter, generating a recommendation according to target input and the subject matter, displaying the recommendation wherein the recommendation includes an action and a deadline, and receiving an action input representing if the action was taken or not taken.

### BACKGROUND OF THE SYSTEM

1) Field of the System

A system for using rolling feedback and natural language processing to extract information from disparate sources for providing predictive analysis used to suggest courses of action in financial planning.

2) Description of the Related Art

In today's economy, the ability to manage cash is a crucial step in the short- and long-term wellbeing of your financial future. Without a comprehensive financial plan, individuals can find themselves living paycheck to paycheck, having insufficient funds to manage unexpected events (e.g. job loss, home or vehicle repair, medical bills, etc.) or not meeting their personal or professional financial goals. Not having sufficient funds to provide for families, plan for the future, and enjoy leisure time which can limit choices and create emotional distress that can lead to depression, low self-esteem, and impaired cognitive functioning. When individuals turn to debt to mask problems with financial planning, problems can be magnified. Having and implementing a financial plan can remove or reduce these risks, financially and emotionally.

Due to their nature, financial plans tend to be customized for each individual, as no two individual's circumstances are exactly alike. Further, financial plans should consider more than just investments and savings and can benefit when they include housing costs and future plans, debt payment (and debt satisfaction), taxes, risk management (e.g. insurance), retirement contributions, general savings, and daily financial needs.

Traditionally, the task of compiling and analyzing this information has been a labor-intensive process requiring the manual review of mortgage documents, bank statements, debt statements, loan documents, tax returns, retirement statements, insurance policies, ratio analysis and other factors. This process does not produce a comprehensive plan that can be useful to customer as it relies on the “artform” rather than an objective analytical automated system. Further, the transitional process can be expensive and limited to the documents of the target individual without consideration of other data sources. Traditionally, this process is typically performed by a financial advisory that relies upon experience learned from each financial plan developed by the advisor. It has been noted that financial advisors who have advanced professional designations and more years of experience, tend to command higher financial planning fees in the marketplace which suggests that the market recognizes varying levels of competence and value, however, this market result could also mean that these advisors are better at marketing their greater credentials and experience than others.

There have been some attempts to automate financial planning, but none provide for the data gathering and rolling feedback of the present system. Further, none include the comprehensive integration of disparate data sources. Further, traditional attempts to automate financial planning are limited in their consideration of the holistic circumstances of the target individual. For example, U.S. Pat. No. 7,536,332 is directed to an implementation of rebalancing an investor's security portfolio based on the specified investment parameters. The method utilizes a conventional mean-variance efficient portfolio frontier analysis, which is often cited in Modern Portfolio Theory (MPT), one of the major scholarly developments in modern finance, finds its way into actually rebalancing the investor's security portfolio. U.S. Pat. No. 6,253,192 is directed to a method of financial planning in which a financial model is created from data relating to a subject's income, expenses, assets, and liabilities. A planning rules database is created from data relating to a preferred financial strategy. This reference is limited to the specific data sources of the subject's income, expenses, assets, and liabilities and does not include sufficient data sources to provide for a comprehensive plan.

U.S. Pat. No. 6,012,043 is a computer implemented tool used primarily in financial planning which produces estimated values of needed savings levels and further income based on certain economic assumptions and data regarding an individual subject's current financial status. The disclosed tool uses decision logic and user preferences to provide output presented in a graphical format. U.S. Pat. No. 5,819,263 is directed to a system for providing proactive service to targets with the disclosed group management system. The system is a work management tool that organizes an advisor's day-to-day operations, workflow, targets, and prospects.

None of these prior attempts include the ability to gather data from disparate data sources, provide for a rolling feedback function and provide for the ability to learn from each target and analyze previous targets and plans for potential updated recommendations.

Therefore, it is an object of the present system to provide for a computerized system that can gather data from disparate data sources for use in the financial planning process.

It is also an object of the present invention to use natural language processing techniques to gather data from disparate data sources for use in the financial planning process.

It is also an object of the present invention to use rolling feedback from prior financial planning projects to provide predictive analysis used to offering courses of action in financial planning.

It is also an object of the present invention to use prospecting functionality to predict potential changes in recommendation to a financial plan based upon input that includes changes in the data of the target and data from new targets.

### BRIEF SUMMARY OF THE SYSTEM

The above objectives are accomplished by providing a computerized rolling feedback system for financial and risk analysis using disparate data sources comprising: a ruleset stored on a first computer readable media having a sub-ruleset associated with a subject matter wherein the subject matter is taken from the group consisting of income, tax, insurance, debt, risk, health care, estate planning, education, or any combination thereof; a target database having a set of target records with each target record having target attributes; a recommendation engine including recommendation computer readable instructions for receiving target input associated with a new target record and subject matter, generating a recommendation according to the new target record and the subject matter, displaying the recommendation wherein the recommendation includes an action and a deadline, and receiving an action input representing if the action was taken; a prospecting engine having prospecting computer readable instructions for receiving the action input, scanning the target database for a first existing target record having similar target attributes to that of the new target record, actuating the recommendation engine for the first existing target record, scanning an external database for changes in subject matter attributes, scanning the target database for a second existing target record having similar subject matter attributes to that of the external database, actuating the recommendation engine for the second existing target record, and scanning the target database for changes in a third existing target record, actuating the recommendation engine for the third existing target record if it is determined that there are changes to a third target record attribute associated with the third existing target record, and, a similarity engine having similarity computer readable instructions for comparing the target input with an existing input and determining if a difference between the target input and the existing input is sufficiently similar to determine that the target input and the existing input are of a same data type.

The similarity engine can determine if the target input and the existing input are of a same document type and can be configured to execute a cosine similarity analysis. The recommendation engine can receive target input using a natural language engine having natural language computer readable instructions for receiving natural language, translating the natural language to a numerical value, generating natural language data derived from the natural language and transmitting the natural language data to the recommendation engine.

The subject matter attributes can be taken from the group consisting of tax rates, insurance rates, interest rates, cost of living, or any combination thereof. The third existing target record includes third existing target record attributes taken from the group consisting of age, children's age, marital status, home ownership, health, health care, income, savings, investments, goals, or any combination thereof. The recommendation engine can include a machine learning unit for updating the ruleset according to the action input. The recommendation engine can include a machine learning unit for updating the ruleset according to a second target input and a second recommendation associated with the second target input. The recommendation engine can receive target input from a third-party electronic source. The target input can be taken from a data source consisting of a computerized system associated with a financial, credit, investment, mortgage, student loan, home institution or combination of such institutions.

The prospecting engine can actuate the recommendation engine for the existing target record if it is determined that a difference in the target attributes exceeds a predetermined range.

### BRIEF DESCRIPTION OF THE SEVERAL VIEWS OF THE DRAWINGS

The construction designed to carry out the system will hereinafter be described, together with other features thereof. The system will be more readily understood from a reading of the following specification and by reference to the accompanying drawings forming a part thereof, wherein an example of the system is shown and wherein:

FIG. 1 is a schematic of various aspects of the system;

FIG. 2A is a schematic of various aspects of the system;

FIG. 2B is a schematic of various aspects of the system;

FIG. 3A is a flowchart of aspects of the system;

FIG. 3B is a flowchart of aspects of the system;

FIGS. 4A through 4F are images representing the display provided to a user and the underlying computer readable instructions of the system;

### DETAILED DESCRIPTION OF THE SYSTEM

With reference to the drawings, the system will now be described in more detail.

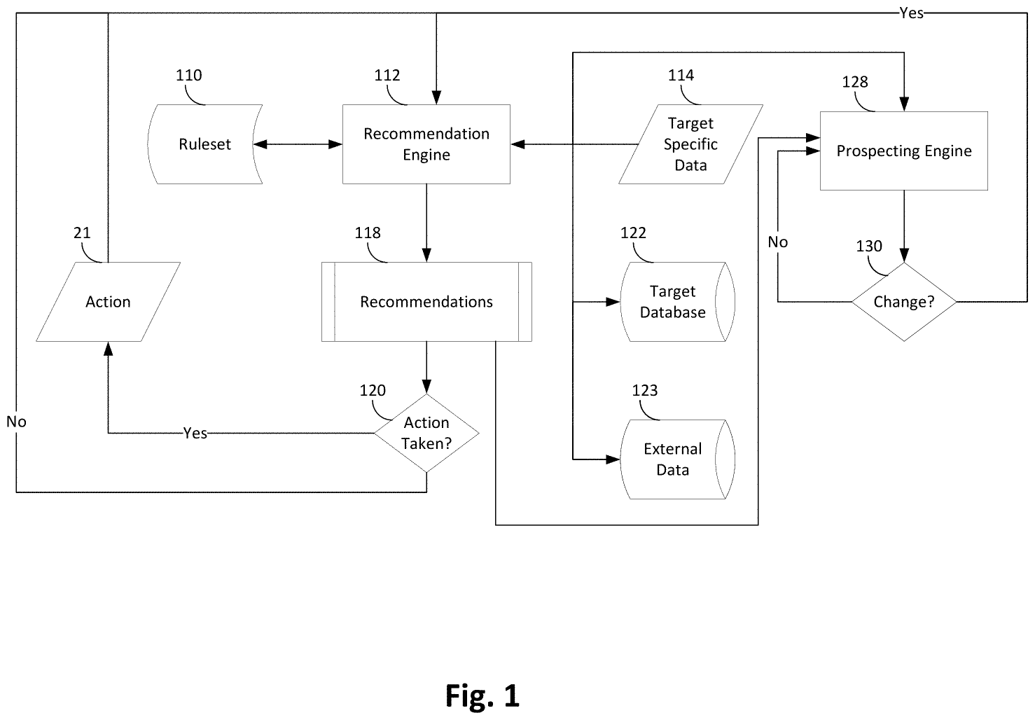

Referring to FIG. 1, the system can include a ruleset 110. The ruleset can be an initial ruleset that is can be generated from information taken from a relevant industry including professionals and experts in the industry or a modified ruleset as described herein. Given that this system is comprehensive system that includes disparate data sources, the ruleset can include sub-rulesets that can each represent an area of an industry or subject matter that can be aggregated for a comprehensive output. For example, when providing recommendations to a professional advisor, the system can use a ruleset that includes sub-rulesets taken from subject matter groups including tax obligations and planning, insurance coverage (including disability, auto, medical, home, life, and others), existing and anticipated debt (including mortgage, student loans, auto, unsecured debt and the like), identify theft risk analysis and prevention, life and the like), long term care planning, estate planning (including wills and trusts) and the like. For example, a consultant in the retirement planning/estate planning fields can be the source of the initial ruleset with rules directed to revocable trusts, how assets should be titled in the trust to comply with the purposes of the trust and the goals and interests of the various parties to the trust. These rulesets can be digitally stored in the system and used as an initial dataset for the recommendation engine 112.

After the initial ruleset is developed, the recommendation engine can update the ruleset according to information that is learned from using the ruleset to develop financial plans for targets. When a target's information is gathered, recommendations are made according to the target's information and actions are recorded and directed to that target, the recommendations made and implemented can be recorded and the ruleset updated to reflect modifications. For example, the initial ruleset may state that once the target reaches a pre-determined age, then investments should be moved from stocks to cash. When subsequent targets are presented with this recommendation at the predetermined age, but the financial planner or the target elect to use a second pre-determined age, the ruleset can be updated to reflect the second pre-determined age so that future recommendations use the second pre-determined age. Therefore, this system can provide for continuous feedback from subsequent events, data and actions taken so that the recommendation engine can continue to provide updated information to the recommendation engine.

When target specific data 114 is entered for a particular target, it can be processed by the recommendation engine and based upon the results of the recommendation engine and the ruleset, provide for recommendations 118 for that target. The target can have attributes that can include the target specific data, demographics, marital status, family, requirement goals, retirement age, geographic location, vacation preferences, hobbies, risk tolerance, assets, health, insurance coverage, occupation, work status, college planning, finances (e.g. expenses, debt, income), estate planning, and the like.

The recommendations can be presented on a user interface that can be used by the financial planner to present options to the target. The recommendations can also be presented in report format and delivered to the target. The report format can be formatted with technical information for the financial planner or formatted for readability for presentation to the target.

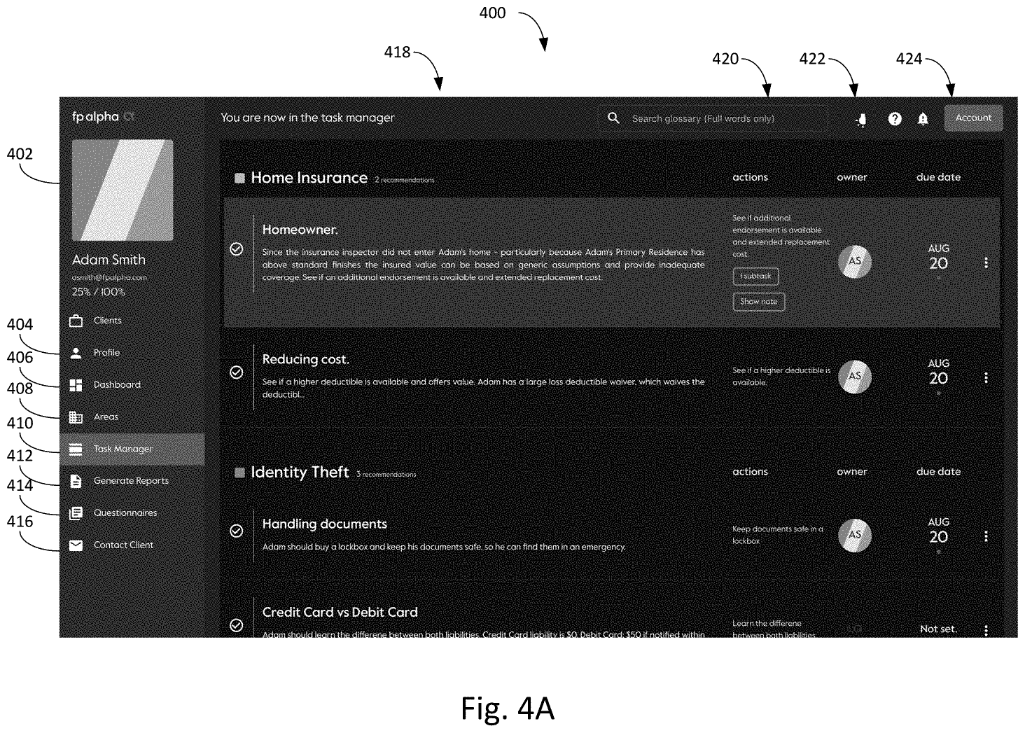

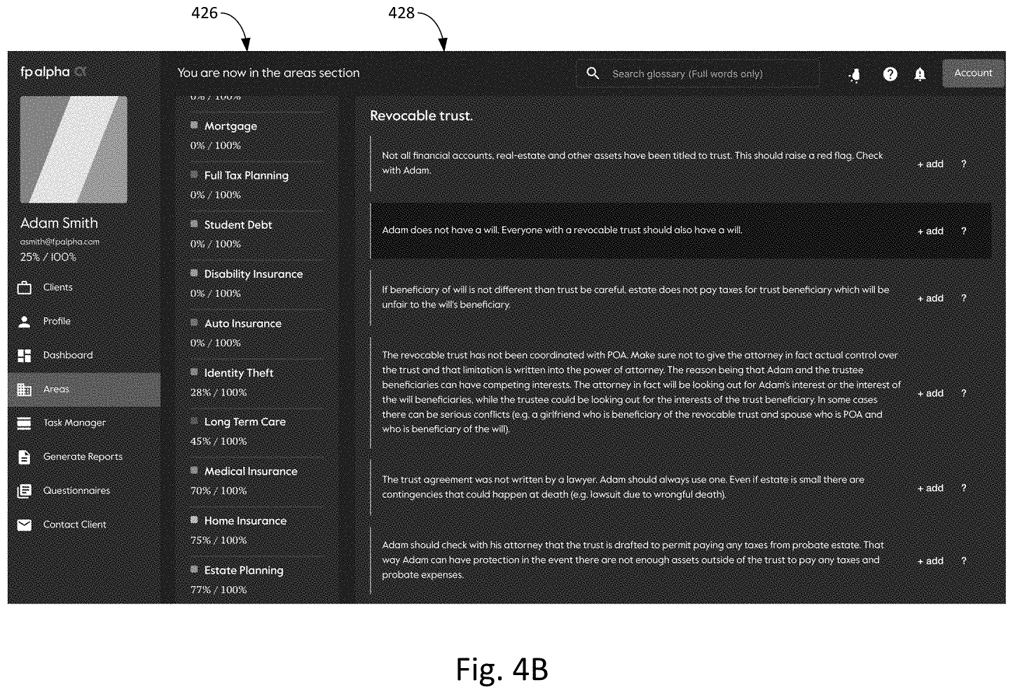

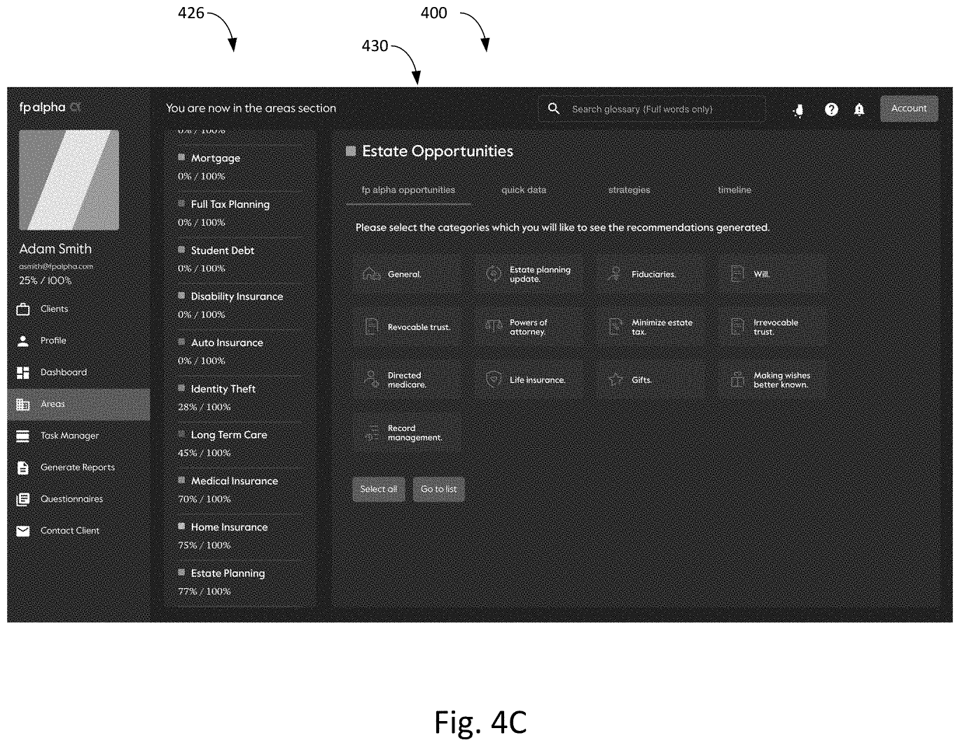

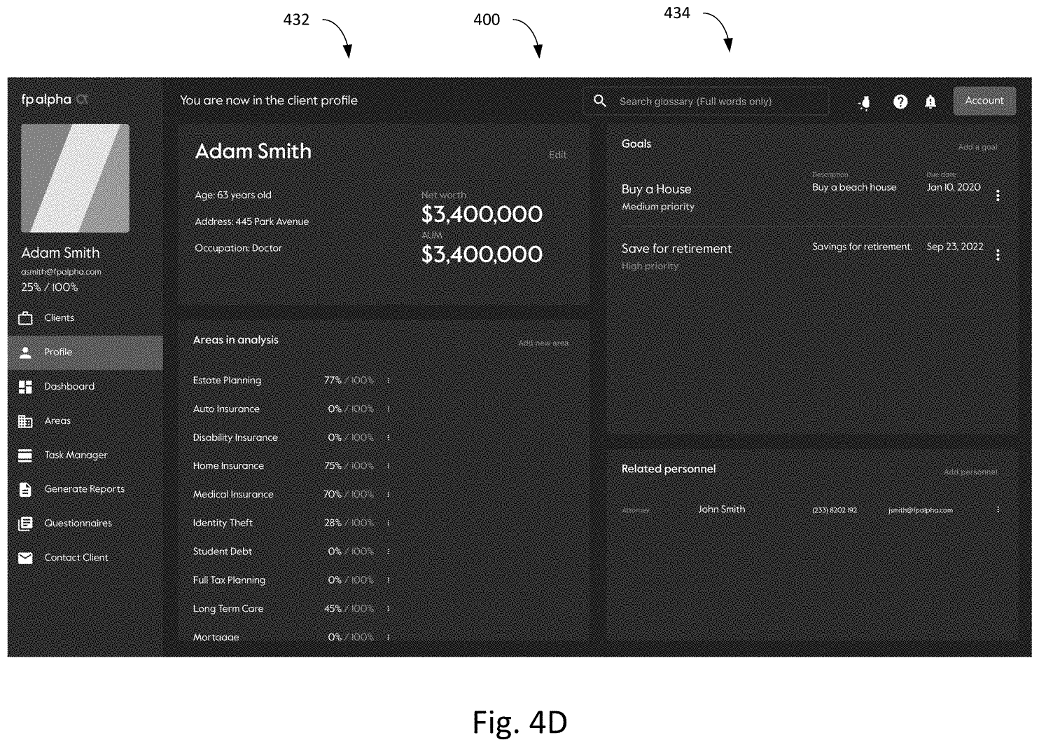

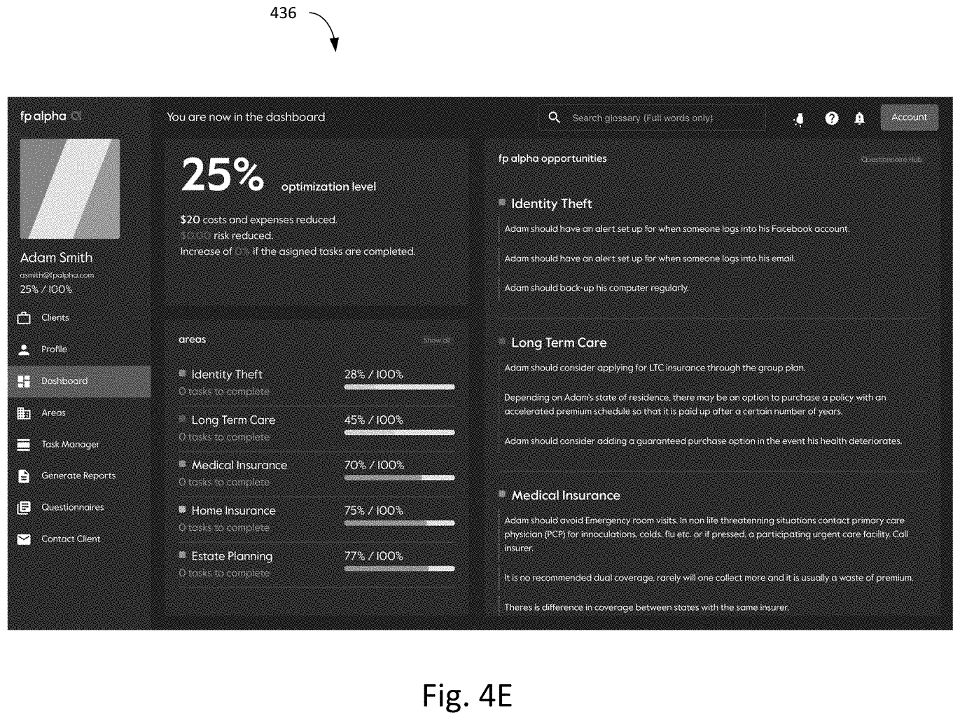

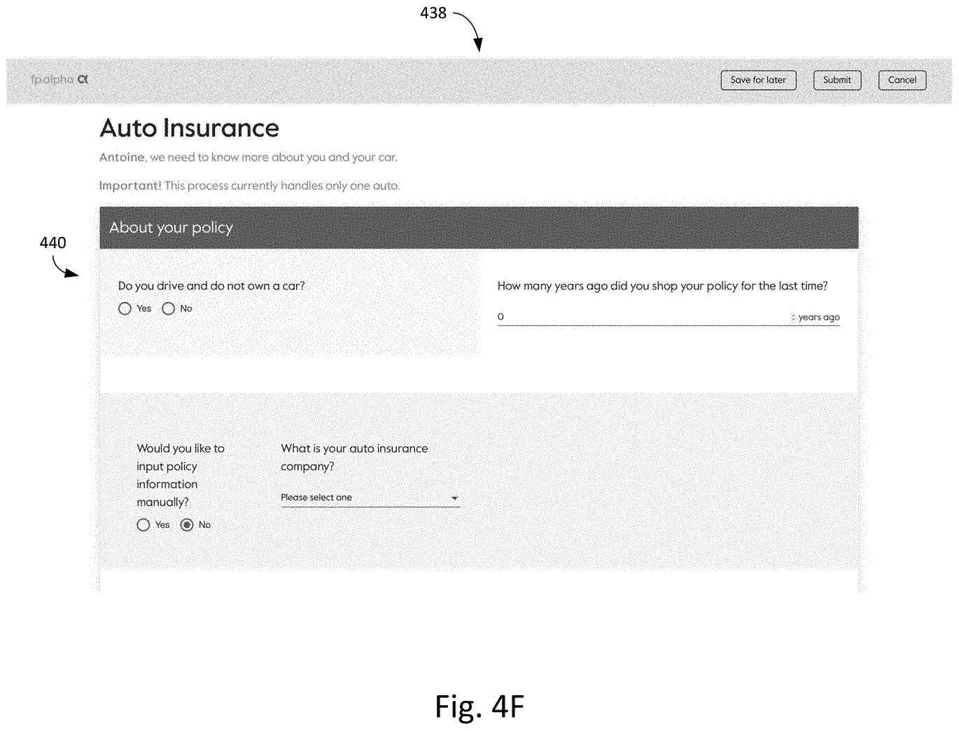

When the recommendations are made, the user can be alerted as to actions to take. These actions can include deadlines associated with the recommendation as shown in FIG. 4A. The user can subsequently determine at 120 if and what action was taken associated with the recommendation. If action was taken, the action can be recorded at 121 and provided to the recommendation engine. The recommendation engine can then use the action (or inaction) and update the ruleset accordingly. The recommendation engine can also draw information from external data sources 123 such as tax rates, interest rates, inflation rates, educational costs (actual and averaged), life span, housing costs, cost of living (including per geographic area), and other information that can affect the future of the target.

The system can include a prospecting engine 128. The prospecting engine can monitor several data sources including target specific data inputted into the system, the target database, external data, and other information sources for changes. When a change is detected, the prospecting engine can actuate the recommendation engine to determine the effect of the change on the target. For example, if the cost of living increases for the geographic region that the target is living, the recommendation engine can provide new or modified recommendations and present these to the financial professional for review and subsequent presentation to the target. The recommendation engine can continuously monitor a target or potential target's information such as the target's financial information, age, family information, or other changes. If there is a change detected at 130 it can be determined if the change exceeds a predetermined threshold or event. If so, the prospecting engine can actuate the recommendation engine and provide the recommendation engine with the changes. In one embodiment, the recommendation engine can receive the actuation from the prospecting engine and generate recommendations from information retrieved by the recommendation engine.

For example, if the prospecting engine determines that a target's children have reached college age and can make recommendations accordingly based upon the target's college financial needs. The prospecting engine can determine that the cost of living in a certain geographic area has changed, determine the targets in the target database that are within the geographical area and actuate the recommendation engine for those affected targets. The prospecting engine can determine that interest rates have changed for certain loans and actuate the recommendation engine for those targets that may be affected by the interest rate change.

The prospecting engine can also detect when a recommendation is made for a first target, determine if there is an existing target with similar attributes for the subject associated with the recommendation, and actuate the recommendation engine to determine if new or modified recommendation, action or inaction should be provided to an existing target in the target database. The prospecting engine can review the target database for existing targets and provide new or modified recommendations based on a new target entered into the system. Once actuated, the recommendation engine can provide new or modified recommendations according to the change detected by the prospecting engine. This allows the system to provide for feedback on a rolling basis when a new target is entered into the system or other changes occur so that existing targets can benefit from subsequent actions or inactions according to recommendations based upon similar attributes.

The process of receiving change information from disparate sources (e.g. new target, third parties, temporal changes, and the like), making recommendations, taking action, electing not to take action, updating target information in the target database and provides for a feedback loop that can further enhance the ability of the recommendation system to provide recommendations for a target. The specific target data can be updated with these changes and recommendations can be provided according to the change. For example, if the target reaches a certain age, recommendations concerning subject matter such as Medicare can be triggered and provided to the financial planner for use in providing services to a target.

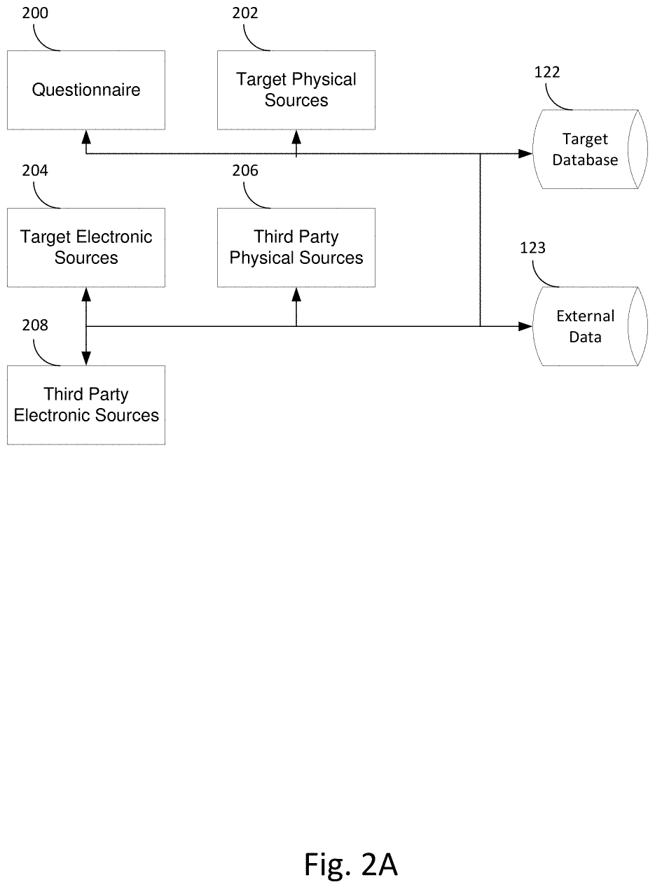

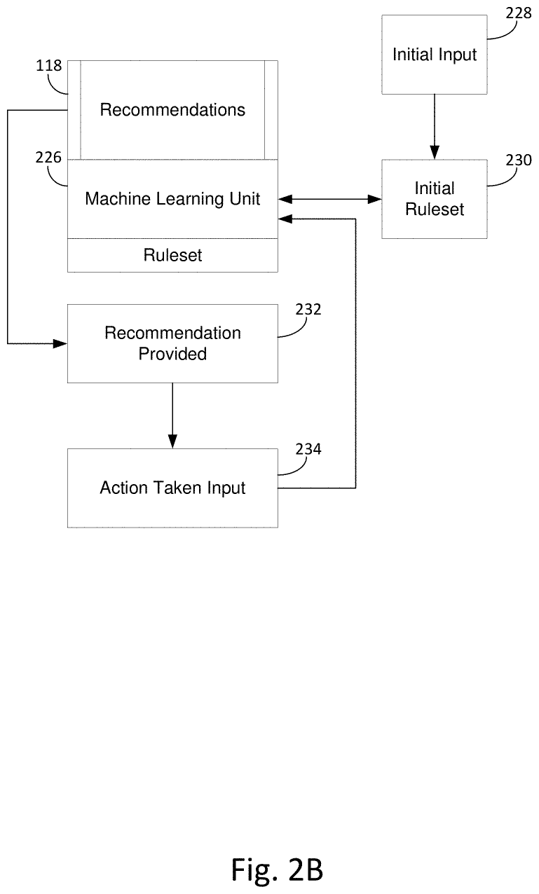

Referring to FIG. 2A, information and data can be retrieved or received from multiple sources including input in response to data requests such as a questionnaire (e.g. written survey or oral interview) response 200. The input from the questionnaire can be associated with the target and stored in the target database. Data and information can also be retrieved from physical sources 202 provided by the target including physical material such as tax returns, insurance policies, wills, trusts, bank statements, credit and loan statements, contracts, and the like. Data sources can also include electronic information from the target such as online information 204 associated with bank accounts, loans, credit facilities and the like. Data sources can also include third party physical information 206 such as financial documents, contracts, insurance policies, and the like. The system can be in electronic communications with third party systems such as banks, financial institutions, credit providers, governmental agencies, third party data providers, and the like so that information can be received by the system without document processing. Data sources can also include third party electronic information 208 such as tax rates, cost of living indexes, educational costs, and the like. The information and data can be stored in the target database or stored in external database accordingly. The data can be associated with the target as well as with an associated target such as a relative or affiliate of the target.

Referring to FIG. 2B, the recommendation engine 118 can include a machine learning unit 226 that can be included in the recommendation engine or can be accessible by the recommendation engine. The machine learning unit can receive initial input 228 from individuals with experience in each subject matter area to creates an initial ruleset 230 which can include sub-rulesets 230 for each subject matter. The rules can include an attribute for a target for each subject matter and a recommended action or inaction including a deadline. The initial ruleset can also include a timeline or deadline associated with the action as well as a priority status (e.g. low, medium, high), and whether the action should be automated or manual. As the system receives targets, the target database is updated, and the recommendation engine provides new recommendations 232 to each new target. As the financial professional indicates if and when an action is taken or to be taken at 234, this information is provided to the machine learning unit. The machine learning unit can determine if the existing ruleset concerning the associated recommendation and action, sufficiently deviate from the information gathered from the financial professional, and modify the ruleset accordingly.

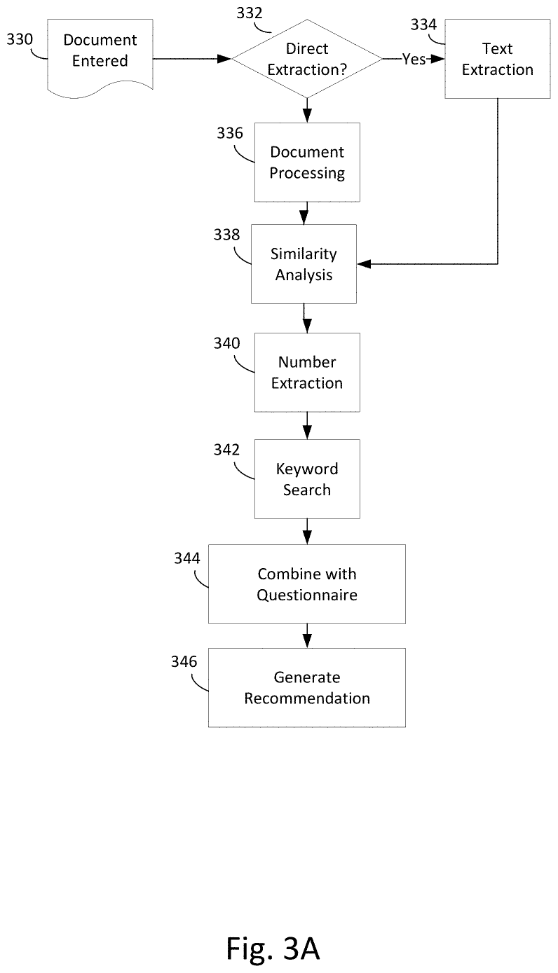

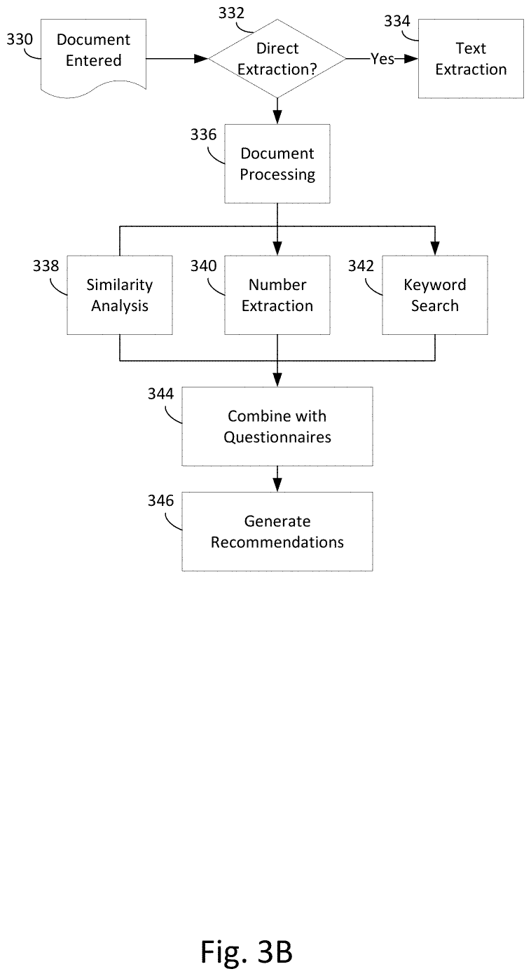

Referring to FIG. 3A, data or information from a physical data source such as a document 330 can be entered into the system. A determination at 332 is made whether the data can be extracted directly from the document or if further processing (e.g. OCR) is needed. The system can extract data from scanned and poorly visible documents and can store the data in raw text so that data can be subsequently reviewed with an indication of potential issues or can be extracted directly from the document and placed in a database. If data can be directly extracted, it is extracted at 334, otherwise the document can be processed such as with OCR or other means at 336. The data from the document can then be processed using similarity analysis at 338. Similarity analysis is the process of identifying concepts within the document to determine if certain concepts are present in the document by determining if it has the same or similar words or data. This process allows the discovery of conditions, clauses, terms, and other information and data in the document that either directly exists or can be determined to exist from words or sentences that could have the same meaning. A simplistic example includes the determination if an insurance policy covers a secondary driver. In this example, the similarity analysis could discover the term “alternate driver”, equate this to secondary driver and determine that the policy does include coverage for a secondary driver and consider this when determining risk and making recommendations to the financial advisor.

This text similarity task also allows risks to be mitigated when the language of legal documents is compared to an existing document that has been proved to be resilient (e.g. tested in court, approved by a third party or otherwise verified) so that the risk of the new document contract being the cause of loss is minimized. As the number of documents analyzed grows, automatic linking of related documents allows the ability to analyze similar or identical situations and for them to be treated similarly.

Number extraction can also be performed on the data at 340. Number extraction is a process where numbers are extracted based on the proximity the number is in the text to a known concept. (e.g. insurance premium). For example, we can look for numbers in the raw text and when we find a number that is the closest in proximity to the terms in the document that represent “total premium” we then can identify that the proper number has been extracted. Numbers can be further processed to remove characters such as “$” and “,” so that calculations can be performed. Once these characters are removed, we can convert to a numeric format so that calculations can be performed.

In one embodiment, the similarity analysis, number extraction and key word search are performed simultaneously as shown in FIG. 3B. Once data extraction is completed, the extracted data can be compared and/or combined with the answers to questionnaires at 344 (and other sources as described herein). Data can originate or be obtained from bank accounts, credit cards, investment accounts, mortgage portals, student loan portals and home values (e.g. as expressed through sites such as Zillow, Trulia, Redfin, Homesnap, Neighborsnap and the like) and client relationship manager (CRM) systems. A CRM can be internal and associated with the user financial professional or can be from a third party that allows access to the data. For example, a target may instruct the target's accountant to grant access to the CRM information of the accountant for use by the system. This may allow the system to retrieve tax and other financial information to be retrieved by the system without the increased cost of the accountant gathering the information and transmitting it to the financial professional and financial professional having to enter the information into the system manually. With the data, the recommendation engine can provide recommendations that can be made at 346 and can include actions to take and deadlines for when the action is recommended to be taken.

The data can also be extracted with keyword searching at 342. Keyword searching is the process of using a predetermined set of works, terms or phrases that are simple to find in documents and can be common. This process scans the documents and looks for keywords in the data. Recommendations can be associated with the predetermined keywords so that when the keyword is discovered, the recommendation can be presented to the financial advisor.

Referring to FIG. 4A, the user screen 400 of the system has various sections that can represent modules including the current target 402, profile 404, dashboard 406, subject matters or areas 408, task manager 410, reports 412, questionnaire enter and review 414 and communications area 416. The modules can be for the system globally or can be filtered for a specific target. The task manager, in this example, is selected for an example target and provided to the user (e.g. financial advisor) with recommendations 418 directed to the target, suggested actions 420, the user 422 and a deadline 424. The recommendations are a product of the analysis of the gathered input from the disparate data sources, the natural language processing, the rolling feedback aspects of the system as provided by the recommendation engine. The priority in which the recommendations are displayed can be according to a ruleset in the various areas, from the ruleset representing the modifications to the ruleset or some combination.

In operation, data from the target is collected and associated with that target in a multitude of areas that include data collection, information and recommendations for the areas of mortgage, tax planning, debt, disability insurance, auto insurance, identify theft protection, long term care, medical insurance, home insurance, estate planning and others. The system can display the percentage of information and analysis that has been completed. The system can also provide indications of priority so that the user (e.g. financial planning professional) can determine which areas need more or less focus.

The system can use natural language process through a natural language processing engine that can include natural language computer readable instructions for determining the type of data that was entered into the system such as contracts, policies, legal documents, financial documents, and the like. The natural language engine can determine if the documents fall into categories such as wills, insurance policies, bank account records and statements, loan documents (e.g. mortgages), assets descriptions, and the like. The natural language engine can remove irrelevant characters, tokenize the text into individual words or phrases, remove irrelevant words (e.g. “@”, “.com”, www.), convert all characters to a common case, combine misspelled words, lemmatization terms, (e.g. reduce words such as “am”, “are”, and “is” to a common form such as “be”) and error checking. The natural language engine can then take the remaining words and convert the text to numerical values, recognize patterns in the values, and build a vocabulary of unique words so that each sentence is represented by a listing of values. The values can be processed to determine the occurrence of any particular word and to determine what category the document best fits (e.g. insurance policy, mortgage, etc.). The natural engine can also determine the rarity of certain words to assist with the categorization and extraction of data from the document. For example, a mortgage would have a higher frequency of the term property than a life insurance policy. As the natural language engine analyzing documents and the results are placed on the system when the financial professional determine the category of the document, the natural language engine rules can be updated so that a similar document in the future will be classified the same as the document classification provided to the first document by the financial professional. Therefore, the natural language engine can learn from the change to the classification of documents made by the financial professional using the system.

Referring to FIG. 4B, the recommendation that can be made within an area 426 (e.g. revocable trust) is shown in more detail. The recommendations are provided from the recommendation engine according to the gathered input from the disparate data sources, the natural language processing, and the rolling feedback aspects of the system. In the example shown, the first recommendation 428 is directed to assets that have been moved into trust.

Referring to FIG. 4C, within each area of the user screen 400, there can be subareas 430 for further refinement of the selected area or subject matter. For example, for the area of estate planning, there can be the subareas or categories 426 that can include general, updates, fiduciaries, wills, trusts, powers of attorney, estate tax, Medicare, life insurance, gifts, goals of the target and recode and document management. In these areas, recommendations can be generated that can be used to assist the target as well as to modify the ruleset. The recommendation engine can recommend an action for a number of items within each area or subarea. Given the number of areas and subareas, there can be multiple feedback loops which can each be tailored for the specific area or subarea.

In collecting data, there are several methods for the data to be received by the system which can be subject matter specific. For example, areas of data that can be received include general information, estate planning, auto insurance, disability insurance, home insurance, medical insurance, identify theft information, student debt, tax planning and long-term care. Information can be received in the form of a questionnaire or can be retrieved from other sources. This data can be in the form of text (e.g. Word documents) or readable documents (e.g. PDF) or other formats (TIFF) allowing the document to be read but not necessarily allowing data to be directly extracted.

The recommendation engine can include computer readable instructions that provide for data extraction and analysis performed on the data which are the associated with the target. When new data representing a new or prospective target is extracted, the new data is stored in a vector that can be compared to the historical data of existing targets. A cosine similarity analysis can be used to compare the new data with the historical data. This analysis determines the cosine of the angle between new data vector and the historical data vector and projects the results in a multi-dimensional space. The results of this analysis are a set of recommendations that existing targets having similar parameters have taken to improve their financial wellbeing. The results are presented as recommendations and suggestions to the financial advisor that can then be discussed with the new or prospective target.

This system can measure the similarity between two non-zero vectors (e.g. the new data and the historical data) of the inner product space and determines the cosine of the angle between these two vectors. The cos θ° is 1 and <1 for any angle in the interval (0, π] radians. The cosine similarity allows a determination of the orientation (not magnitude) of the two vectors. Using cosine similarity, the information retrieved in the data extraction and historical data can be assigned a different dimension. The results of the analysis can be characterized by a vector where the value in each dimension corresponds to the number of times the term appears in the document or data. Cosine similarity allows the determination of how similar two documents are concerning their subject matter. The function of the analysis can be represented as:

$$similarity = cos ( θ ) = \frac{A \times B}{‖ A ‖ ‖ B ‖} = \frac{{\sum }_{i = 1}^{n} {A}_{i} {B}_{i}}{\sqrt{{\sum }_{i = 1}^{n} {A}_{i}^{2}} {\sqrt{{\sum }_{i = 1}^{n} {B}_{i}^{2}}}^{2}} \qquad ( 1 )$$

where Aᵢ and Bᵢ are components of the vector A and B respectively.

The system can include computer readable instructions for comparing existing data with historical data such as Pearson's product-moment correlation which can be illustrated by the following formula:

$$r = \frac{n ( \sum xy ) - ( \sum x ) ( \sum y )}{\sqrt{[ n \sum {x}^{2} - {( \sum x )}^{2} ] [ n \sum {y}^{2} - {( \sum y )}^{2} ]}} \qquad ( 2 )$$

Spearman's correlation which can be illustrated, in one embodiment, by the following formula:

$$ρ = 1 - \frac{6 \sum {d}_{i}^{2}}{n ( {n}^{2} - 1 )} \qquad ( 3 )$$

Jaccard's Similarity (coefficient) which can be illustrated by the following formula:

$$J ( A , B ) = \frac{\vert A ⋂ B \vert}{A ⋃ B} = \frac{\vert A ⋂ B \vert}{\vert A \vert + \vert B \vert - \vert A ⋂ B \vert} \qquad ( 4 )$$

Using one or more of these methods the system can determine the relevance between difference in a net target information, existing target information, information changes, changes input or any combination thereof. For example, a first-year tax return can be entered for a target. A second-year tax return can be entered for the target. Similarity analysis can be performed to determine the relevance of any differences between the two returns.

Further, the system can use similarity analysis to determine the similarity of a first data when compared to a second data. If a document is entered, the system can determine the similarity of the document and existing data in the system's database. The system can determine that the document is similar to a loan document and therefore that the information to be pulled from the document is associated with a loan. With this feature, the system can retrieve documents from third parties, receive documents in electronic form or have document scans entered and determine the information type and relevance of the document information.

When a new target is accepted, the profile of the target can be displayed to the user such as with a profile screen 432 shown in FIG. 4D. The user screen 400 can quickly display and represent the functionality of the system and can include vital statistics, goals, related targets or other individuals, and areas of analysis of the target with percentage of completeness. The profile can also display basic information of the target, editable by the user, and including age, address, occupation, net worth, etc. a screen area 434. Users can also add goals and contact information, as well as adding or removing areas of planning for the target.

The target can also have information displayed in a dashboard 436 as shown in FIG. 4E. When capturing data, a questionnaire can be used to capture data from the target using questionnaire screen 438 and questionnaire data requests 440 as shown in FIG. 4F, representing one data request for one topic of one subject matter.

By way of example the operation of the system can be shown by the process and steps described herein. This example is to provide those skilled in the art with one example of the description of the operation of this system and is not to be limited. In this example, the target or potential target can provide basic information about the target (birthday, address, etc.). Information about the target can be obtained from a survey, bank records, credit card records, investments accounts, mortgage providers, student loans providers, home value informational sources and the like. For example, the system can be in electronic communications with a student loan provider so that information about the student loan can be retrieved from the student loan provider into the system. The system can also create a list of documents to be requested from the target. When these documents are provided, information about the target can be gathered automatically. The information can be sent to an email account or other destination that can be received by the system automatically. The documents can be processed (e.g. data extraction) automatically by the system. Once the information is processed, recommendations can be generated and provided to the financial planner. The financial planner can then meet with the target and review any recommendations and actions. Based on whether the target takes or does not take an action. The system can update the target associated information to reflect the decision of the target. The learning engine uses the initial information, the actions, and the actions and information from other targets to provide the recommendation engine with the information needed to provide recommendations.

It is understood that the above descriptions and illustrations are intended to be illustrative and not restrictive. Other embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventor did not consider such subject matter to be part of the disclosed inventive subject matter.

Further, embodiments within the scope of the present invention may also include computer-readable media for carrying or having computer readable or computer executable instructions or data tables, or data structures stored thereon. Such computer readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code in the form of computer executable instructions or data structures. When information is transferred or provided over a network or another communications connection (either hardwired, wireless, or combination thereof) to a computer, the computer properly views the connection as a computer readable medium. Thus, any such connection is properly termed a computer readable medium. Combinations of the above should also be included within the scope of the computer-readable media.

Computer readable instructions include, for example, instructions and data which cause a general computer, special purpose computer, or special purpose processing device to perform a certain function or group of functions. Computer readable instructions also include program modules that are executed by computers in stand-alone or network environments. Generally, program modules include routines, programs, objects, components, and data structures, etc. that perform particular tasks or implement particular abstract data types. Computer readable instructions, associated data structures, and program modules represent examples of the program codes for executing steps of the methods disclosed herein. The particular sequence of such executable instructions or associated data structures represents examples of corresponding acts for implementing the functions described in such steps.

Those of skill in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

Although the above description may contain specific details, they should not be construed as limiting the claims in any way. Other configurations of the described embodiments of the invention are part of the scope of this invention. For example, the order of acts in the exemplary process illustrated by flowcharts and schematics may be changed. Accordingly, the appended claims and their legal equivalents should only define the invention, rather than any specific examples given.

What is claimed is:

1. A computerized rolling feedback system for financial and risk analysis using disparate data sources comprising:
a ruleset stored on a first computer readable media having a sub-ruleset associated with a subject matter wherein the subject matter is taken from the group consisting of income, tax, insurance, debt, risk, health care, estate planning, education, or any combination thereof;
a target database having a set of target records with each target record having target attributes;
a recommendation engine including recommendation computer readable instructions for receiving target input associated with a new target record and subject matter, generating a recommendation according to the new target record and the subject matter, displaying the recommendation wherein the recommendation includes an action and a deadline, and receiving an action input representing if the action was taken;
a prospecting engine having prospecting computer readable instructions for receiving the action input, scanning the target database for a first existing target record having similar target attributes to that of the new target record, actuating the recommendation engine for the first existing target record, scanning an external database for changes in subject matter attributes, scanning the target database for a second existing target record having similar subject matter attributes to that of the external database, actuating the recommendation engine for the second existing target record, and scanning the target database for changes in a third existing target record, actuating the recommendation engine for the third existing target record if it is determined that there are changes to a third target record attributes associated with the third existing target record, and,
a similarity engine having similarity computer readable instructions for comparing the target input with an existing input and determining if a difference between the target input and the existing input is sufficiently similar to determine that the target input and the existing input are of a same data type.

2. The computerized rolling feedback system of claim 1 wherein the similarity engine determines if the target input and the existing input are of a same document type.

3. The computerized rolling feedback system of claim 2 wherein the similarity engine includes similarity computer readable instructions configured to execute a cosine similarity analysis.

4. The computerized rolling feedback system of claim 1 wherein the recommendation engine receives target input using a natural language engine having natural language computer readable instructions for receiving natural language, translating the natural language to a numerical value, generating natural language data derived from the natural language and transmitting the natural language data to the recommendation engine.

5. The computerized rolling feedback system of claim 1 wherein subject matter attributes are taken from the group consisting of tax rates, insurance rates, interest rates, cost of living, or any combination thereof.

6. The computerized rolling feedback system of claim 1 wherein the third existing target record includes third existing target record attributes taken from the group consisting of age, children's age, marital status, home ownership, health, health care, income, savings, investments, goals, or any combination thereof.

7. The computerized rolling feedback system of claim 1 wherein the recommendation engine includes a machine learning unit for updating the ruleset according to the action input.

8. The computerized rolling feedback system of claim 1 wherein the recommendation engine includes a machine learning unit for updating the ruleset according to a second target input and a second recommendation associated with the second target input.

9. The computerized rolling feedback system of claim 1 wherein the recommendation engine receives target input from a third-party electronic source.

10. The computerized rolling feedback system of claim 9 wherein the target input is taken from a data source consisting of a computerized system associated with a financial, credit, investment, mortgage, student loan, home institution or combination of such institutions.

11. A computerized rolling feedback system for financial and risk analysis using disparate data sources comprising:
a ruleset stored on a first computer readable media having a sub-ruleset associated with a subject matter;
a target database having a set of target records with each target record having target attributes;
a recommendation engine including recommendation computer readable instructions for receiving target input associated with a new target, generating a recommendation according to target input for a subject matter, displaying the recommendation, and receiving an action input representing if an action associated with the recommendation was taken; and,
a machine learning unit for updating the ruleset according to the recommendation and action input.

12. The computerized rolling feedback system of claim 11 including a similarity engine having similarity computer readable instructions for comparing the target input with an existing input and determining if a difference between the target input and the existing input is sufficiently similar to determine that the target input and the existing input are of a same data type.

13. The computerized rolling feedback system of claim 11 including a prospecting engine having prospecting computer readable instructions for receiving the action input, scanning the target database for an existing target record having similar target attributes to that of the new target, and actuating the recommendation engine for the existing target record.

14. The computerized rolling feedback system of claim 11 including a prospecting engine having prospecting computer readable instructions for scanning an external database for changes in subject matter attributes, scanning the target database for an existing target record having similar subject matter attributes to that of the external database, actuating the recommendation engine for the existing target record.

15. The computerized rolling feedback system of claim 11 including a prospecting engine having prospecting computer readable instructions for and scanning the target database for changes in an existing target record and actuating the recommendation engine for the existing target record if it is determined that there is a difference in the target attributes.

16. The computerized rolling feedback system of claim 15 wherein the prospecting engine actuates the recommendation engine for the existing target record if it is determined that a difference in the target attributes exceeds a predetermined range.

17. The computerized rolling feedback system of claim 11 including a similarity engine having similarity computer readable instructions for comparing the target input with an existing input and determining if a difference between the target input and the existing input is sufficiently similar to determine that the target input and the existing input are of a same data type.

18. A computerized rolling feedback system for financial and risk analysis using disparate data sources comprising:
a ruleset stored on a first computer readable media having sub-rulesets associated with a set of subject matters;
a target database having a set of target records; and,
a recommendation engine including recommendation computer readable instructions for receiving target input associated with a new target record, generating a recommendation according to the target input, displaying the recommendation, and receiving an action input representing if an action associated with the recommendation was taken.

19. A computerized rolling feedback system of claim 18 including a similarity engine having similarity computer readable instructions for comparing the target input with an existing input and determining if a difference between the target input and the existing input is sufficiently different to determine that the target input and the existing input are of a same data type.

20. A computerized rolling feedback system of claim 18 including a prospecting engine having prospecting computer readable instructions for receiving the action input, scanning the target database for a first existing target record having similar target attributes to that of the new target record, actuating the recommendation engine for the first existing target record, scanning an external database for changes in subject matter attributes, scanning the target database for a second existing target record having similar subject matter attributes to that of the external database, actuating the recommendation engine for the second existing target record, and scanning the target database for changes in a third existing target record, actuating the recommendation engine for the third existing target record.

21. A computerized rolling feedback system of claim 18 including a prospecting engine having prospecting computer readable instructions for receiving the action input, scanning the target database for an existing target record having similar target attributes to that of the new target record, and actuating the recommendation engine for the existing target record.

22. A computerized rolling feedback system of claim 18 including a prospecting engine having prospecting computer readable instructions for scanning an external database for changes in subject matter attributes, scanning the target database for an existing target record having similar subject matter attributes to that of the external database and actuating the recommendation engine for the existing target record.

23. A computerized rolling feedback system of claim 18 and scanning the target database for changes in an existing target record, actuating the recommendation engine for the existing target record if there are changes to the existing target record.
